(19) United States
(12) Patent Application Publication
(10) Pub. No.: US 2005/0258632 A1
(43) Pub. Date: Nov. 24, 2005

(54) Parking location reminder and business advertisement

(76) Inventor: Bradford Currier, Rochester, MN (US)

Correspondence Address: Craig F. Taylor;Fredrikson & Byron, P.A., 4000 Pillsbury Center, 200 South Sixth Street, Minneapolis, MN, 55402-1425, US

(21) Appl. No.: 10/851,488

(22) Filed: May 21, 2004

(51) Int. Cl. G09F 1/00; G08G 1/14

(52) U.S. Cl. 283/56

(57) ABSTRACT

Methods and devices for providing parking reminders for people parking at parking facilities. Parking reminders are provided including both a parking location and an advertisement for a business. The advertisement for the business can be used to directly or indirectly pay for the cost of the parking reminders. Some parking reminders are printed paper products including a printed business name and optional business location together with an advertisement which can include an optional coupon good for a discount and/or additional goods or services at the business. The parking reminder can include parking sublocations, such as parking levels or parking lot subsections. The invention also provides parking reminder dispensers which can be located at exit points for parking facilities such as elevators or other exit points. Some dispensers provide electronically transmitted parking reminders through electromagnetic and/or optical signals. Some devices dispense electronic parking reminders to personal digital assistants or pocket personal computers through infrared or Bluetooth signals. The parking reminders thus provided can be used to assist parkers in finding their vehicles when parking in unfamiliar parking facilities, to be paid for through the increased business at the supporting businesses buying the advertisement on the parking reminders.

### FIELD OF THE INVENTION

The present invention is related generally to parking facilities, including automobile parking facilities. More specifically, the present application is related to devices, methods, and services for reminding people of a parking location.

### DESCRIPTION OF RELATED ART

Parking facilities are commonplace in industrialized countries. Large parking facilities have been in existence for decades. People parking in large parking facilities on a regular basis, for example, at or near a place of employment, may often have reserved parking spaces or remember to park in a similar region of the facility. People in such situations are often able to find their vehicle without undue trouble.

People often park in large parking facilities that are unfamiliar to them. Examples of such large, unfamiliar parking lots are multi-level parking lots in downtown areas, large parking facilities associated with airports, and large parking facilities surrounding shopping malls. People parking in such parking lots often believe they will be able to remember where their vehicle is located, but may have a great deal of difficulty finding their vehicles when returning from the downtown area, shopping mall, or airport. In some situations, where there is paid parking, the person parking has a ticket which identifies the parking facility, but does not identify any sublocation within the parking facility. For example, the person parking may know that they parked at the airport parking ramp, but have no other printed indication to narrow down their parking location. Some people take the printed parking ticket with them from their vehicle to the airport terminal, and may even write down what they believe to be useful information, but risk losing the parking ticket on their trip and returning to the airport. The problem may be exacerbated by the lack of any apparent standard in identifying the parking location to the person parking. While it would be beneficial for parkers to be given a parking reminder accurately identifying their parking location and sublocation, there is no financial driving force for the airport, the mall as a whole, or the downtown shopping area as a whole, to provide such parking reminders. Detailed, printed parking location reminders would be beneficial to the people parking.

In a seemingly unrelated problem, business establishments may be located within short distance of the large parking facilities, businesses that, if known, would be visited by the person parking. As the person parking is often in a strange, unfamiliar parking facility, as well as a strange, unknown area, this potential patron of the business establishment is unaware of the existence of the potentially desirable business establishment. What would be advantageous is a way to direct people parking to a particular business establishment.

### SUMMARY OF THE INVENTION

The present invention provides devices and methods for providing parking reminders for people parking at parking facilities. The parking reminders can include both a parking location and a business advertisement. The parking location can include a sublocation and the business advertisement can include a redeemable coupon. The parking reminder can be paid for by the businesses advertised, through the paid advertising on the parking reminders. The parking reminders may find some uses at airport related parking facilities and at parking facilities in downtown metropolitan areas.

The present invention includes a printed article including a paper product, a printed parking location printed on the paper product, and a printed advertisement for a business printed on the paper product. Some printed articles include a business location on the business advertisement that is located near the parking location. Some printed articles include a business location that is located within about 1,000 yards of the parking location. In some printed articles, the parking location is primarily for airport parking and the business is located within an airport terminal. Some advertisements include a coupon for the business, where the coupon is redeemable for a reduced price and for additional goods or services. Some printed articles include a blank region that can be added to with handwriting.

The present invention also provides a parking location reminder device including several parking location reminders having a parking location and a business advertisement, and a dispenser for dispensing the parking location reminders. In some embodiments, the parking reminders are formed of a paper product and have printed parking location reminders and printed advertisements. In other embodiments, the reminders are transmitted through signals, which can include optical or electromagnetic signals. Some devices dispense both printed and electronic reminders. The dispenser can be located near the printed parking location. In some devices, the dispenser prints out at least part of the parking location, and in other devices, the dispenser prints out at least part of the advertisement. The device can dispense printed parking reminders having the printed parking location located within about 1,000 yards of the business location. The device can be located in an airport related parking facility where the business is located in an airport terminal. In some devices, the reminder content is changed responsive to remotely transmitted signals received by the device. Some devices can generate audible instructions to take a reminder, in response to the sensed proximity of people.

The present invention further provides a method for providing a parking location reminder for a parking location. The method can include dispensing the parking location reminder, where the reminder includes a printed parking location. The method also includes dispensing a business advertisement for a business having a location near the parking location and near the dispenser. The method can include the advertisement having a coupon, which can be redeemable for a reduced price and/or additional goods or services from the business. In some methods, the dispensing includes electronic dispensing through electromagnetic or optical signals. In other methods, the dispensing includes dispensing a printed-paper article.

The present invention also provides a parking facility including several parking spaces for motorized vehicles, several parking location reminders including a parking location and a business advertisement, and a parking location reminder dispenser for dispensing the parking location reminders. The dispenser is preferably located directly at the parking facility, and can dispense the parking reminder through a printed-paper product and/or through an electronically transmitted electromagnetic or optical signal carrying the parking reminder. In some parking facilities, the parking reminder dispenser is located within about 50 feet of an elevator in the parking facility. In some facilities, the business advertised is at a location within about 1,000 yards of a parking facility. Some parking facilities are primarily for airport related parking and the business advertised on the parking reminder is a business located within an airport terminal.

The present invention also includes a method for promoting a business, where the business has a location. The method includes dispensing a business advertisement at a parking facility, where the advertisement is for the business, where the business advertisement is dispensed with a parking location reminder identifying a parking location for the parking facility. The method can include dispensing through electronically transmitting the advertisement and parking location reminder through electromagnetic or optical signals. The method may also include dispensing a printed article including the advertisement as a printed advertisement and the parking reminder as a printed reminder. The method can include the advertisement having a coupon for the business. The method can promote a business located within an airport terminal, where the dispenser is located within a parking facility primarily for airport related parking.

### DESCRIPTION OF THE DRAWINGS

FIG. 1 is a fragmentary, perspective view of a parking reminder dispenser situated near an elevator in a parking facility;

FIG. 2 is a perspective view of a simple parking reminder dispenser;

FIG. 3 is a perspective view of another, simple parking reminder dispenser;

FIG. 4 is a perspective view of another parking reminder dispenser including a paper product parking reminder dispenser and an electronic signal parking reminder dispenser for PDAs or pocket personal computers;

FIG. 5 is a fragmentary view of a parking reminder dispenser including multiple push buttons for selecting parking sublocations for printing on the parking reminder;

FIG. 6A is the front side of a parking reminder including the parking facility location and sublocation;

FIG. 6B is the back side of the parking reminder of FIG. 6A, including an advertisement for a business including a coupon for a discount at the business;

FIG. 7 is a schematic diagram of a parking reminder dispenser including a processor, an electronic signal parking reminder transmitter, and a paper product parking reminder dispenser; and

FIG. 8 is a highly diagrammatic, side, cutaway view of a simple PDA implemented parking reminder dispenser.

### DETAILED DESCRIPTION OF THE PREFERRED EMBODIMENTS

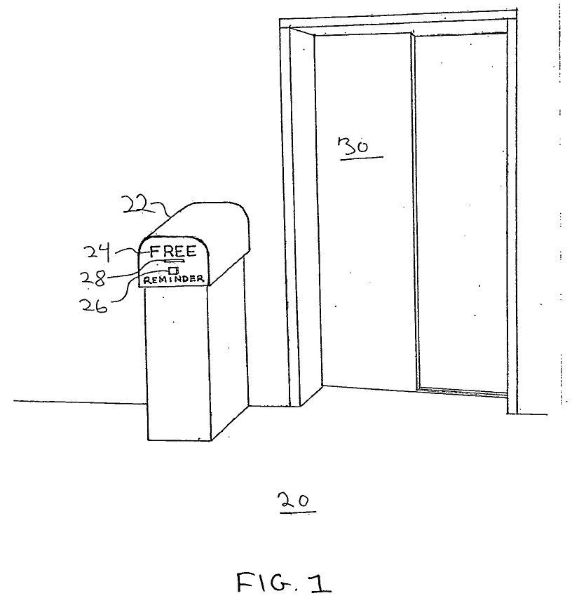

FIG. 1 illustrates a parking reminder dispenser 22 situated in a parking facility 20 near an elevator 30. As will be discussed later, parking reminder dispensers can be situated in multi-level or large surface parking facilities and can be located at different locations within the parking facilities. Examples of suitable locations include elevators, ramps, entries, and exits from the parking facility. Parking reminder dispenser 22 can dispense both a reminder of the parking location and optionally the sublocation together with an advertisement for a business. Parking dispenser 22 includes a sign 24 indicating that a free parking reminder is available. A button 26 can be depressed to dispense the parking reminder through a dispensing slot 28. Some dispensers simply dispense preprinted paper product tickets while other dispensers print at least part of the parking reminder on demand, and can include the date and time of the printing of the parking reminder. Parking reminder dispensers can, in some embodiments, be identical to the dispensers used to dispense parking tickets encountered when entering parking ramps. Such parking ticket dispensers typically have preprinted parking tickets with a time printed additionally on the parking tickets as the button is pushed on the machine. In one embodiment, the present invention is implemented by printing an advertisement for a business establishment on part of the ticket, either preprinted on the ticket or printed on demand along with the date and time. Examples of such parking ticket dispensers are provided by Amano Cincinnati (www.amano.com) (Roseland N.J.).

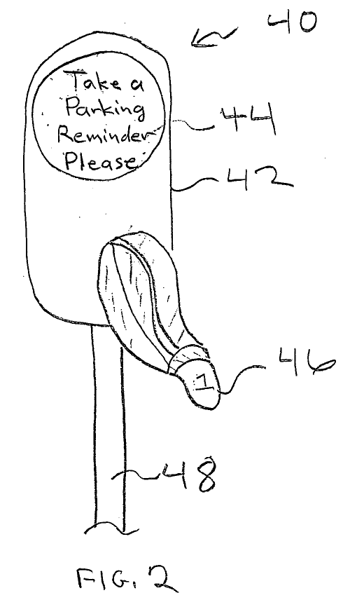

FIG. 2 illustrates a simple parking reminder dispenser 40 including generally a sign at 44 indicating that a ticket may be taken, a ticket dispenser body 42, and a parking reminder 46 being dispensed. Parking reminder dispenser 40 can be mounted on a pedestal 48 which can be secured to the floor or wall of a parking facility. Simple dispensers such as dispenser 40 are available from manufacturers such as Flogo (www.flogo.com). Parking reminder 46 can include simply a preprinted parking location and/or sublocation on one side and a business advertisement on the same or opposite side.

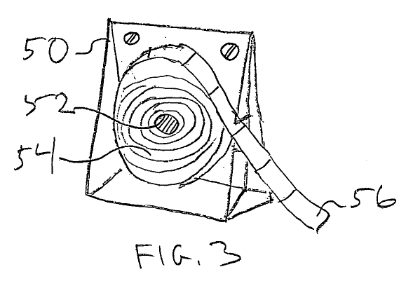

FIG. 3 illustrates yet another parking reminder dispenser 50 which is formed of a generally translucent material having a roll of tickets 54 mounted on a spindle 52. Parking reminder 56 may be simply torn from the roll. As previously discussed, parking reminder 56 can have both a parking location and sublocation and a business advertisement, which can include a coupon for the business.

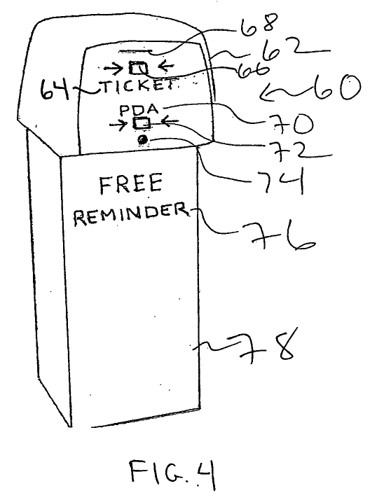

FIG. 4 illustrates still another parking reminder dispenser 60 including generally a dispenser body 62 including both a paper product parking reminder and an electronic signal parking reminder. A printed indication at 64 indicates that a printed reminder is available, together with a push button 66 and a paper product parking reminder dispensing slot 68. Pushing button 66 can result in a ticket being dispensed through slot 68 and can include at least part of the parking reminder being printed on demand. An indicator of a personal digital assistant (PDA) parking reminder is indicated at 70 together with a push button 72. Pushing button 72 can cause an electromagnetic, audio, and/or optical signal to be transmitted from transmitter 74 to be received by, audio recorder, a personal digital assistant, or a pocket personal computer. Transmitter 74 can utilize various signal transmission formats, depending on what is currently in use. Examples of electronic parking reminders that can be transmitted from transmitter 74 include infrared optical signals and Bluetooth radio frequency signals. A user can hold up their own personal PDA or pocket PC near transmitter 74 to receive the electronic parking reminder. In some methods and devices, the signals can be transmitted repeatedly and continually, not requiring that a button be pushed. As previously discussed, the parking reminder dispenser can include a printed indicator of a free reminder at 76, here shown printed on a pedestal 78.

FIG. 5 illustrates part of a parking reminder dispenser 80 that can issue printed parking reminders including parking sublocations on the parking reminder. Parking reminder dispenser 80 includes a reminder at 82 to choose a parking space sublocation. Some dispensing devices generate an audible reminder to “Please take a free parking location reminder,” which may be triggered by movement or proximity of a person. Such audible reminders may be found in various embodiments of both printed reminder and electronically transmitted reminder devices, located both in fixed locations and shuttle buses. Several parking sublocation rows are indicated at 86 and several parking sublocation columns are indicated at 84. Several buttons 90 can be pushed to select which parking sublocation row and column the user parked at. The set of rows and columns, indicated at 88, can be fed to a processor to select the parking sublocation row and column where the user parked, which can be printed on demand, on a ticket or parking reminder issuing from dispensing slot 92. A parking reminder dispenser such as dispenser 80 may find one use at the exit point from a large parking facility having a large surface area and/or multiple levels. Parking reminder dispenser 80 can find another use on a shuttle bus at an airport related parking facility, where the user and/or the shuttle bus driver can push one of the buttons to issue the parking reminder having the correct sublocation printed on the ticket.

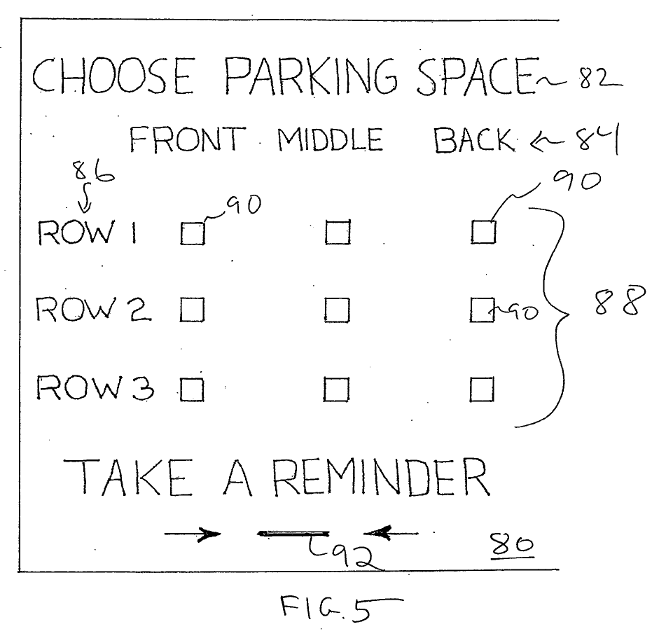

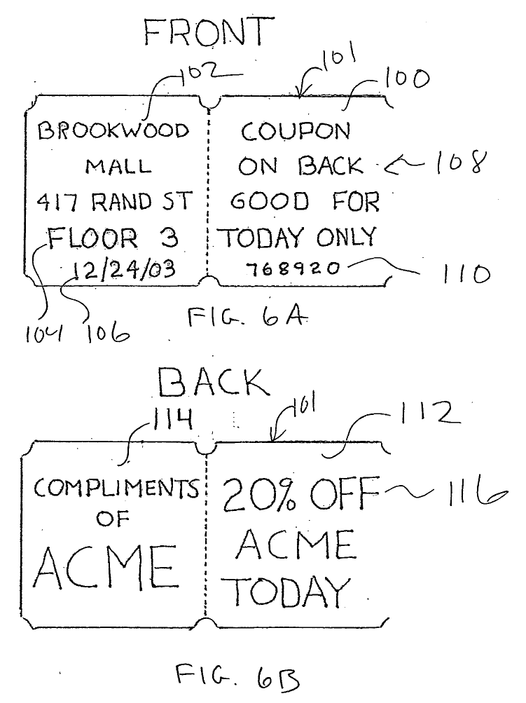

FIG. 6A illustrates a parking reminder 101 having a front side 100 including a parking facility name and location at 102 and a sublocation at 104. A date may be seen at 106. Parking reminder 101 also includes an indicator that the parking reminder has a coupon, indicated at 108. The parking reminder also includes a serial number at 110, which can be either preprinted or printed on demand depending on the embodiment.

FIG. 6B shows a back side 112 to parking reminder 101. Back side 112 includes a business advertisement at 114 and a coupon at 116. In some examples of the invention, the business advertisement also includes a location of the business. This location of the business can include, for example, a street address, an Internet address, a building name, a map, or a location within an airport terminal. Where present, the coupon portion of the parking reminder can include a redeemable coupon for a discount and/or additional goods and/or services at no additional charge. In some examples of the invention, the coupon is redeemable only during the day on which the coupon is issued, for example, the date printed on the parking reminder itself. In one example of the invention, the parking dispenser is located within about 1,000 yards from the business advertised, for example, within about 1,000 yards of the business location printed on the parking reminder, where present.

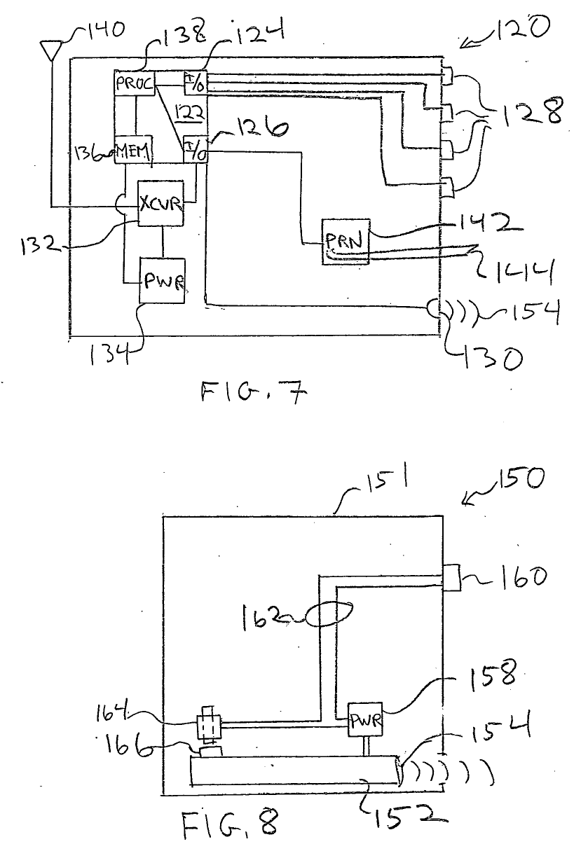

FIG. 7 illustrates a highly diagrammatic implementation of a parking reminder dispenser 120. Parking reminder dispenser 120 includes generally a processor board 122 coupled to several push buttons 128 and a printer 142. Processor board 122 may be implemented in many ways, well known to those skilled in the art. In the example illustrated, processor board 122 includes generally a processor 138, computer memory 136, and 10 handling devices 124 and 126. Push buttons 128 can be coupled to processor board 122 through 10 device 124 to indicate a parking sublocation to be printed on the parking reminder and/or the demand for a printed parking reminder and/or an electronically issued parking reminder. Processor 138 can determine which action is to be performed based upon which of buttons 128 is pushed. Processor 138 can issue a data stream to printer 142 through 10 device 126 to be printed on paper product parking reminder 144. As previously discussed, the printed parking reminder can include the parking facility location, a parking sublocation, a date, a time, and a business advertisement, which can include a business location and a coupon. A transmitter 130 is also shown, which can be used to transmit an electronic or optical signal 154 carrying a parking reminder to a PDA or a pocket PC or the like. Transmitter 130 indicates a generic transmitter, and is used to represent an electromagnetic transmitter and/or an optical transmitter. A power source 134 is indicated in dispenser 120. In some embodiments, power source 134 is a battery power source, while in other embodiments, the parking dispenser is powered by line current.

Dispenser 120 can also include a transceiver, indicated generally at 132 and coupled to an antenna 140. Antenna 140 can be used to receive updates to the messages to be printed on the printed and/or electronically issued parking reminders. In this way, the business advertisement and/or coupons can be updated remotely. In some examples of the invention, transceiver 132 can be used to transmit indications of low power and/or a low number of tickets or paper remaining. Processor 122 may be implemented using any number of single board processor devices available on the market.

FIG. 8 illustrates a simple implementation of a PDA receivable parking reminder dispenser 150. Dispenser 150 includes generally a personal digital assistant (PDA) 152 within an enclosure 151. Dispenser 150 includes a power source 158 coupled to PDA 152 and to an externally mounted push button 160. Push button 160 is coupled through wires 162 to a plunger solenoid 164 which can be used to depress a button 166 on PDA 152 to send signal 154. Devices may include the user buttons being hardwired to, or integrated with, the transmitting or controlling device. PDAs, for example, those made by Palm or Sony, typically have a document that can be selected to be beamed upon depressing the address book button for longer than a set period of time. For example, the Sony CLIE will send a preselected file upon depressing the address book button for longer than about one second. The transmitted document can be a preselected address book selection, which can include user selectable text. Some devices allow macros including the date and time to be inserted within a document and generated upon demand. Some devices may also allow one of the limited number of mechanical buttons, for example about four buttons, to be coupled directly to transmit a selected document upon depressing the selected button. PDAs typically emit an infrared signal upon selection of this beaming function. In some devices, the power off function can be disabled, while in other devices, a separate solenoid may be required to power up a powered down PDA. In other devices, the PDA can be made to send a signal responsive to sensing a nearby person, or continuously or repeatedly, to avoid having to press a button. Dispenser 150 can also be implemented using a pocket PC, in a similar fashion.

In some examples, the electronic parking reminder dispenser will transmit a file that will automatically appear in the memo pad of a PDA. The day and date in the message can be updated using macros or through a simple software program. The information can include the name and address of the parking facility and the specific location of the dispensing device, for example, a sublocation such as a level or a section of a parking facility. The memo may also have a space for the PDA owner to add information concerning the exact parking space or other pertinent information if desired. An advertisement can be attached to the memo. The advertisement can include a coupon which can be redeemable in some examples of the invention. In one embodiment of the invention, the coupon can be redeemable by displaying the PDA memo including the coupon at the business and/or by transmitting the coupon from the PDA to a receiver at the business location. The cost of maintaining and refilling the parking reminder dispensers can be paid for, directly, or indirectly, by the businesses being advertised on the parking reminders. In some uses of the invention, the businesses pay a flat fee for the advertisements being dispensed at a location. In other uses of the invention, the businesses pay based on the number of advertisements that direct people to the business establishment. In some uses of the invention, the businesses pay based on the number of coupons redeemed at the business establishment that originated at the parking reminder dispensers.

All publications, patents and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

1. A printed article comprising:
a paper product;
a printed parking location printed on the paper product; and
a printed advertisement for a business printed on the paper product, where the advertisement is not for a parking business.

2. The printed article of claim 1, wherein the business advertisement includes a business location that is located near the printed parking location.

3. The printed article of claim 1, wherein the business advertisement includes a business location that is located within about 1000 yards of the printed parking location.

4. The printed article of claim 1, wherein the parking location is primarily for airport parking and wherein the business is located within an airport terminal.

5. The printed article of claim 1, wherein the advertisement includes a coupon for the business.

6. The printed article of claim 5, wherein the coupon is redeemable for a reduced price.

7. The printed article of claim 5, wherein the coupon is redeemable for additional goods or services.

8. The printed article of claim 1, in which the printed parking location includes a blank region that can be added to with handwriting.

9. The printed article of claim 1, in which the business advertisement includes a telephone number and/or address for the business.

10. A parking location reminder device comprising:
a plurality of parking location reminders formed of a paper product having a printed parking location and a printed business advertisement where the advertisement is not for a parking business; and
a dispenser for dispensing the parking location reminders, wherein the dispenser is located near the printed parking location.

11. The device of claim 10, wherein the dispenser prints out at least part of the parking location.

12. The device of claim 10, wherein the dispenser prints out at least part of the advertisement.

13. The device of claim 10, wherein the advertisement includes a coupon for the business for a reduced price and/or additional goods or services.

14. The device as in claim 10, wherein the printed parking location is located within 1000 yards of the printed business location.

15. The device as in claim 10, wherein the printed parking location is primarily for airport related parking and wherein the business is located in an airport terminal.

16. The device as in claim 10, further comprising means for transmitting the parking location electronically.

17. The device as in claim 10, further comprising means for transmitting the business advertisement electronically.

18. The device as in claim 10, wherein the business advertisement includes a printed business location, wherein the business location is within about 1000 yards of the parking location.

19. A method for providing a parking location reminder for a parking location, the method comprising:
dispensing the parking location reminder, the reminder including a parking location; and
dispensing a business advertisement for a business, where the business is not a parking business.

20. The method of claim 19, in which the advertisement includes a coupon.

21. The method of claim 20, in which the coupon can be used to obtain a reduced price from the business.

22. The method of claim 20, in which the coupon can be used to obtain additional goods or services from the business.

23. The method of claim 19, in which the dispensing includes electronic dispensing through electromagnetic or optical signals.

24. The method of claim 19, in which the dispensing includes dispensing a printed paper article.

25. The method of claim 24, in which the dispensing the printed paper article includes printing at least part of the advertisement and/or parking location.

26. The method of claim 25, further comprising receiving a remotely generated signal, in which the printing is varied responsive to the received signal.

27. The method of claim 19, in which the parking location is near the business location.

28. The method of claim 19, in which the parking location is within about 1000 yards of the business location.

29. The method of claim 19, in which the parking location is primarily for airport related parking and in which the business location is within an airport terminal.

30. The method of claim 19, further comprising generating an audible message to accept the parking reminder generated responsive to detecting the presence of a person near the dispenser.

31. The method of claim 19, in which the dispensing includes dispensing a phone number and/or address for the business.

32. The method of claim 19, in which the dispensing is performed in a shuttle bus serving the parking facility.

33. A parking facility comprising:
a plurality of parking spaces for motorized vehicles;
a plurality of parking location reminders including a parking location and a business advertisement that is not for a parking business; and
a parking location reminder dispenser for dispensing the parking location reminders.

34. The parking facility of claim 33, in which the parking location and business advertisement are both printed on a paper product.

35. The parking facility of claim 33, in which the parking location and business advertisement are both transmitted through an electromagnetic or optical signal.

36. The parking facility of claim 33, in which the parking facility includes a plurality of identifiable sub-locations, in which the parking location reminder parking location includes the sub-location.

37. The parking facility of claim 36, in which the sub-locations include a level location in a multi-level parking ramp, wherein the parking reminder dispenser is located within about 50 feet of an elevator in the parking facility.

38. The parking facility of claim 36, in which the sub-locations include a portion of a surface parking lot.

39. The parking facility of claim 33, in which the business advertisement advertises a business location within about 1000 yards of the parking facility.

40. The parking facility of claim 33, in which the parking lot facility is primarily for airport related parking and in which the business advertisement includes a business location within an airport terminal.

41. The parking lot facility of claim 33, in which the business advertisement includes a coupon.

42. A method for promoting a business, wherein the business has a location, the method comprising:
dispensing a business advertisement that is not for a parking business at a parking facility, wherein the advertisement is for the business, wherein the business advertisement is dispensed with a parking location reminder identifying a parking location for the parking facility.

43. The method of claim 42, in which the dispensing includes electronically transmitting the advertisement and parking location reminder through electromagnetic or optical signals.

44. The method of claim 42, in which the dispensing includes dispensing a printed article including the advertisement as a printed advertisement and the parking reminder as a printed reminder.

45. The method of claim 44, in which the dispensing includes varying the advertisement responsive to receiving a remotely generated signal.

46. The method of claim 42, in which the advertisement includes a coupon for the business and in which the dispensing includes dispensing the coupon.

47. The method of claim 42, in which the business is located in an airport terminal and in which the parking facility is primarily for airport related parking.

48. The device as in claim 10, further comprising a receiver for receiving radio frequency signals operably coupled to a printer for printing updated advertisements received through the receiver.

49. The method of claim 26, in which the printing includes printing a gift-giving reminder for an annually recurring holiday.

50. The method of claim 49 in which the reminder includes a suggestion to buy flowers, and in which the holiday is Valentines Day.
